(19) United States
(12) Patent Application Publication
(10) Pub. No.: US 2025/0178705 A1
(43) Pub. Date: Jun. 5, 2025

(54) WATERCRAFT INFORMATION COLLECTING SYSTEM

(71) Applicant: YAMAHA HATSUDOKI KABUSHIKI KAISHA, Iwata-shi (JP)

(72) Inventors: Hiroshi INOUE, Shizuoka (JP); Hidehiko HARADA, Shizuoka (JP); Yuji IKEDA, Shizuoka (JP); Atsushi OCHI, Shizuoka (JP); Jan NIMITSOPON, Shizuoka (JP)

(21) Appl. No.: 18/962,242

(22) Filed: Nov. 27, 2024

(30) Foreign Application Priority Data
Nov. 30, 2023 (JP) 2023-203274

(51) Int. Cl. B63B 69/00; G06Q 10/0833

(52) U.S. Cl. CPC B63B 69/00; G06Q 10/0833; B63B 2203/00

(57) ABSTRACT

A watercraft information collecting system includes an onboard system and a server outside a watercraft. The onboard system includes watercraft devices on the watercraft, an onboard network on the watercraft and connected to the watercraft devices, and a communication terminal communicable with the watercraft devices via the onboard network. The server is communicable with the communication terminal. The communication terminal is configured or programmed to execute a system scanning process to collect information about the watercraft devices and a scanning result transmission process to transmit a scanning result including the information collected by the system scanning process to the server. The server is configured or programmed to register the scanning result received from the communication terminal and to collect at least one of position information about the watercraft or information about a distribution stage of the watercraft.

### CROSS REFERENCE TO RELATED APPLICATIONS

This application claims the benefit of priority to Japanese Patent Application No. 2023-203274 filed on Nov. 30, 2023. The entire contents of this application are hereby incorporated herein by reference.

### BACKGROUND OF THE INVENTION

### 1. Field of the Invention

The present invention relates to watercraft information collecting systems. Further, the present invention relates to communication terminals and servers to be used with the watercraft information collecting systems. In addition, the present invention relates to watercraft each including an onboard system to be used with the watercraft information collecting systems.

### 2. Description of the Related Art

US 2018/0006810 A1 discloses an onboard system that collects vehicle configuration information and an information sharing system that has a server communicating with the onboard system. The server collates the vehicle configuration information, acquired through communication with the onboard system, with vehicle condition management information. An arrangement is thereby provided where new confidential information can be shared safely between the server and a vehicle without storing confidential information in the vehicle in advance.

### SUMMARY OF THE INVENTION

The inventors of example embodiments of the present invention described and claimed in the present application conducted an extensive study and research regarding a watercraft information collecting system, such as the one described above, and in doing so, discovered and first recognized new unique challenges and previously unrecognized possibilities for improvements as described in greater detail below.

US 2018/0006810 A1 does not disclose anything regarding information collection related to a watercraft.

Thus, example embodiments of the present invention provide watercraft information collecting systems suitable for information collection related to watercraft. Also, example embodiments of the present invention provide communication terminals and servers suitable for use in the watercraft information collecting systems. Further, example embodiments of the present invention provide watercraft including onboard systems used in the watercraft information collecting systems.

In order to overcome the previously unrecognized and unsolved challenges described above, an example embodiment of the present invention provides a watercraft information collecting system including an onboard system including a plurality of watercraft devices on a watercraft, an onboard network on the watercraft and connected to the plurality of watercraft devices, and a communication terminal communicable with the plurality of watercraft devices via the onboard network and a server outside the watercraft and communicable with the communication terminal. The communication terminal is configured or programmed to execute a system scanning process to collect information about the plurality of watercraft devices and a scanning result transmission process to transmit a scanning result which is the information collected by the system scanning process to the server. The server is configured or programmed to register the scanning result received from the communication terminal and to collect at least one of position information about the watercraft or information about a distribution stage of the watercraft.

With this arrangement, the onboard system is configured by connecting the plurality of watercraft devices to the onboard network. Via the onboard network, the communication terminal is communicable with the plurality of watercraft devices and the server outside the watercraft. In an example embodiment, the communication terminal executes the system scanning process to collect the information about the plurality of watercraft devices and transmits the scanning result to the server. The server registers the scanning result received from the communication terminal. The server further collects at least one of the position information about the watercraft or the information about the distribution stage of the watercraft.

The position information about the watercraft can be used, for example, to specify a region in which the watercraft is actually used and can therefore be used as reference information for development and design of the watercraft devices. The information about the distribution stage can be used, for example, as reference information for production management and distribution management of the watercraft devices.

Since the scanning result obtained by the system scanning process is registered in the server, for example, evaluation of the scanning result can be performed by the server. In this case, the system scanning process can be performed and the evaluation of such a system scanning process can be performed even without connecting a specialized service tool, not included in the onboard system, to the onboard network. Therefore, if the onboard system is constructed appropriately and accordingly, the evaluation of the scanning result is satisfactory, a diagnostic task performed by connecting the specialized service tool can be omitted. Labor and time for diagnosis of the onboard system can thus be reduced or minimized.

In an example embodiment of the present invention, the watercraft information collecting system further includes a distribution stage specifier to specify the distribution stage of the watercraft. The server is configured or programmed to collect information about the distribution stage specified by the distribution stage specifier. With this arrangement, the distribution stage of the watercraft is specified and the specified information is collected by the server. The information about the distribution stage thus collected can be used, for example, as reference information for the production management and the distribution management of the watercraft devices.

In an example embodiment of the present invention, the plurality of watercraft devices include a positioning system. The distribution stage specifier includes a shipment determiner to determine that the watercraft has been shipped when the positioning system detects a position separated by a predetermined distance or more from an initial position detected by the positioning system when the communication terminal executes the system scanning process for a first time.

The positioning system is one of the plurality of watercraft devices and thus detects a position of the onboard system, that is, a position of the watercraft. A location where the communication terminal executes the system scanning process for the first time is a location where the onboard system is constructed, that is, a location where the watercraft is built and is typically a factory of a boatbuilder. Thus, when a movement by the predetermined distance (for example, several kilometers) from the initial position (the factory of the boatbuilder) when the system scanning process is executed for the first time is detected, it can be determined that the watercraft has been shipped from the boatbuilder.

In an example embodiment of the present invention, the communication terminal is further configured or programmed to execute a position information transmission process to transmit the position information detected by the positioning system to the server. The server is configured or programmed to execute the function of the shipment determiner. That is, in this case, the server acquires the position information about the watercraft from the communication terminal.

In an example embodiment of the present invention, the communication terminal is configured or programmed to acquire the position information detected by the positioning system and to execute the function of the shipment determiner. In this case, the communication terminal transmits a determination result by the shipment determiner to the server. The server acquires the determination result as information about the distribution stage.

In an example embodiment of the present invention, the plurality of watercraft devices include a propulsion device. The distribution stage specifier includes a customer delivery determiner to determine that the watercraft is delivered to a customer when a cumulative operation period of the propulsion device exceeds a predetermined threshold.

Until the watercraft is delivered to a customer upon being built, test operation of the propulsion device is executed as necessary. Obviously, this operation period is a short period compared to an operation period from start of use upon delivery to the customer. Thus, when the cumulative operation period of the propulsion device exceeds the predetermined threshold (for example, 10 hours), it can be determined that the watercraft has been delivered to the customer.

In an example embodiment of the present invention, the communication terminal is further configured or programmed to execute an operation period information transmission process to transmit operation period information about the propulsion device to the server. The server is configured or programmed to execute the function of the customer delivery determiner. In this case, whether or not delivery to the customer has been performed is determined by the server.

In an example embodiment of the present invention, the communication terminal is configured or programmed to acquire the operation period information about the propulsion device and to execute the function of the customer delivery determiner. In this case, the communication terminal transmits determination result about customer delivery, that is, information about whether or not delivery to the customer has been performed to the server. The server acquires the determination result as information indicating the distribution stage.

In an example embodiment of the present invention, the communication terminal is configured or programmed to compare the scanning result of a previous system scanning process and the scanning result of a latest system scanning process, not to execute the scanning result transmission process when the two scanning results are consistent with each other, and to execute the scanning result transmission process when the two scanning results are inconsistent with each other. The plurality of watercraft devices include a propulsion device. When a cumulative operation period of the propulsion device exceeds a predetermined threshold, the communication terminal is configured or programmed to transmit the latest scanning result to the server regardless of consistency/inconsistency with the previous scanning result.

With this arrangement, if a new scanning result and a previous scanning result are inconsistent with each other, the scanning result is transmitted to and accumulated in the server. The server may execute an evaluation on the new scanning result. On the other hand, if the new scanning result and the previous scanning result are consistent with each other, the scanning result transmission process is omitted and therefore, accumulation of the scanning result and other processes by the server are not executed. Loads on the communication terminal and the server can thus be lightened.

On the other hand, when the cumulative operation period of the propulsion device exceeds the predetermined threshold, the latest scanning result is transmitted to the server regardless of whether or not it is consistent with the previous scanning result. Information about the plurality of watercraft devices at the point at which the cumulative operation period of the propulsion device exceeds the threshold can thus be acquired by the server. By setting the threshold to an appropriate value (for example, approximately 10 hours), the server can acquire information about the plurality of watercraft devices after the watercraft has been delivered to the customer. By examining this, it can be confirmed whether or not the watercraft of an appropriately configured state has been delivered to the customer.

For example, the communication terminal may be configured or programmed to execute the system scanning process when startup of the onboard system is detected. Thus, the scanning result accumulated in the server can be kept up to date.

In an example embodiment of the present invention, the server is configured or programmed to attach a label identifying the distribution stage to the scanning result received from the communication terminal. With this arrangement, the scanning result at each stage of distribution can be examined by searching using the label as a key. The distribution stage refers to a stage such as unshipped, shipment completed, customer delivery completed, etc. In particular, by attaching the label indicating customer delivery completed, configuration information about the watercraft delivered to the customer can be extracted and examined easily.

In an example embodiment of the present invention, the plurality of watercraft devices include a propulsion device, a GNSS (global navigation satellite system) positioning system, and a cellular base station positioning system. Also, based on a predetermined determination condition, position information generated by either of the GNSS positioning system and the cellular base station positioning system is selected and accumulated in the server. The determination condition includes at least one of a condition regarding the operation period of the propulsion device or a condition regarding an agreement of the customer in regard to position information collection.

With this arrangement, based on the determination condition, the position information generated by either of the GNSS positioning system and the cellular base station positioning system can be collected and accumulated in the server. The GNSS positioning system can detect an accurate position of the watercraft. On the other hand, the cellular base station positioning system can merely detect that the watercraft is positioned inside a communication range of a cellular base station with which communication with the communication terminal is established, and therefore, its positioning precision is lower than that of the GNSS positioning system.

For example, the position information detected by the GNSS positioning system may be accumulated in the server when the cumulative operation period of the propulsion device is less than a predetermined threshold and the position information detected by the cellular base station positioning system may be accumulated in the server when the cumulative operation period of the propulsion device reaches the threshold. For example, by setting the threshold to an appropriate value (for example, approximately 10 hours), accurate position information can be collected before delivery to the customer and, on the other hand, position information of low precision can be collected after delivery to the customer. Also, the position information detected by the GNSS positioning system may be accumulated in the server when the customer has agreed to collection of accurate position information and the position information detected by the cellular base station positioning system may be accumulated in the server when the customer has not agreed to the collection of accurate position information. The collection of position information can thus be performed appropriately while respecting the customer's wishes.

An example embodiment of the present invention provides the communication terminal used in the watercraft information collecting system described above.

An example embodiment of the present invention provides the server used in the watercraft information collecting system described above.

An example embodiment of the present invention provides a watercraft including a hull and the onboard system used in the watercraft information collecting system described above.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram that outlines a watercraft information collecting system according to an example embodiment of the present invention.

FIG. 2 is a block diagram that describes a configuration of a watercraft by way of example.

FIG. 3 is a block diagram that describes a configuration of a server by way of example.

FIG. 4 is a block diagram showing a configuration of a communication terminal by way of example.

FIG. 5A is a block diagram that describes a configuration of a dealer client by way of example.

FIG. 5B is a block diagram that describes a configuration of a user client by way of example.

FIG. 6 is a flowchart that describes an exemplary operation to be performed by the communication terminal.

FIG. 7 is a flowchart that describes an example of a periodic transmission process (step S10 of FIG. 6) to be performed by the communication terminal.

FIG. 8 is a flowchart that describes an example of a process performed by the server.

FIG. 9 is a diagram that describes a second example embodiment of the present invention and shows another example of a periodic transmission process to be performed by the communication terminal.

FIG. 10 is a diagram that describes a third example embodiment of the present invention and shows an example where a distribution stage specifying process is executed by the communication terminal.

### DETAILED DESCRIPTION OF THE EXAMPLE EMBODIMENTS

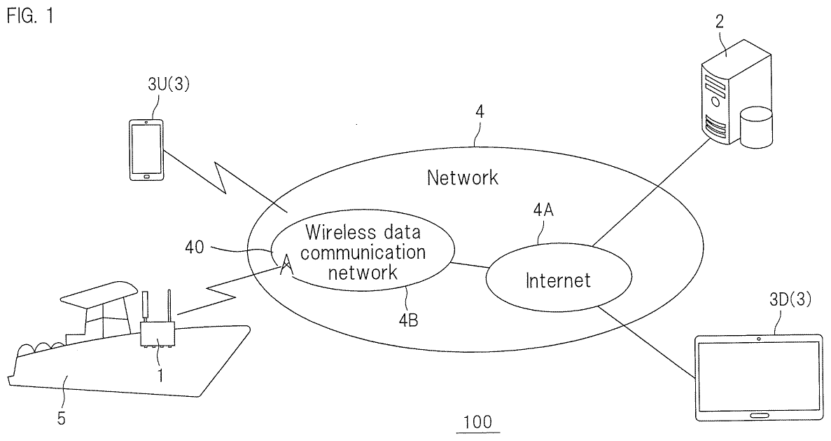

FIG. 1 is a diagram that outlines a watercraft information collecting system according to an example embodiment of the present invention. A watercraft information collecting system 100 includes a communication terminal 1 to collect and transmit information about devices on a watercraft 5, and a server 2 to communicate with the communication terminal 1. The communication terminal 1 may be provided on the watercraft 5. Further, the communication terminal 1 may be portable, so that a crew member can bring the communication terminal 1 onto the watercraft 5.

The communication terminal 1 and the server 2 are communicable with each other via a network 4. That is, the communication terminal 1 and the server 2 are each connected to the network 4 in a communicable manner. The network 4 typically includes an internet 4A. The communication terminal 1 is connected to a wireless data communication network 4B such as a mobile phone network in a communicable manner, and is connected to the internet 4A via the wireless data communication network 4B in a communicable manner. The wireless data communication network 4B includes a cellular base station 40 that is wirelessly communicable with the communication terminal 1.

The server 2 is typically communicable with a client 3. The client 3 may be a client terminal provided in a dealer office and/or a marina office (hereinafter referred to as “dealer client 3D”). Further, the client 3 may be a mobile terminal such as a smartphone to be carried by a user (hereinafter referred to as “user client 3U”). The dealer client 3D may be configured to be connectable to the internet 4A via a local area network (not shown) provided in the office, or may be configured to be connectable to the internet 4A via the wireless data communication network 4B. The user client 3U is typically configured to be connectable to the internet 4A via the wireless data communication network 4B. Further, the user client 3U may be connected to the communication terminal 1 in a data communicable manner in the watercraft. In this case, the user client 3U may be connectable to the network 4 via the communication terminal 1.

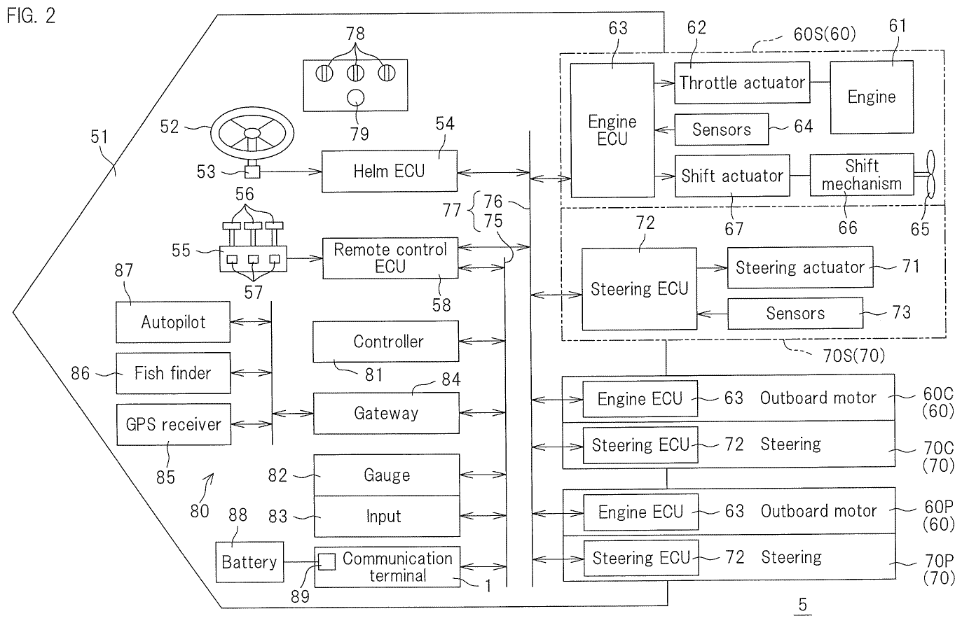

FIG. 2 is a block diagram that describes the configuration of the watercraft 5 by way of example. The watercraft 5 includes a hull 51, and various devices on the hull 51 (watercraft devices). The watercraft devices typically include an input device to maneuver the watercraft 5 (watercraft maneuvering device), a controller 81 to comprehensively control the devices on the watercraft 5, a propulsion device to apply a propulsive force to the hull 51, and a steering device (watercraft maneuvering device) to change the advancing direction of the hull 51. In an example embodiment, the communication terminal 1 is one of the watercraft devices.

In this example, the input device includes a steering wheel 52 and a remote controller 55.

In this example, the propulsion device includes an outboard motor 60 as an exemplary main device (main propulsion device). Specifically, the outboard motor 60 includes one or more outboard motors 60 provided on the stern. In this example, a plurality of outboard motors 60 (more specifically, three outboard motors 60) are disposed side by side and attached to the stern. In this example, the outboard motors 60 are engine outboard motors each including an engine 61 (internal combustion engine) as a power source to drive a propeller 65. Of course, electric outboard motors each including an electric motor as a power source may be used. Specifically, the three outboard motors 60 include a middle outboard motor 60C disposed in the middle, and a port-side outboard motor 60P and a starboard-side outboard motor 60S disposed on the left side and the right side, respectively, of the middle outboard motor 60C.

In this example, the steering device includes steerings 70 to respectively steer the outboard motors 60 leftward and rightward. The steerings 70 are provided in one-to-one correspondence with the outboard motors 60. In this example, three steerings 70 are provided. The three steerings 70 include a middle steering 70C, a port-side steering 70P, and a starboard-side steering 70S, which correspond to the middle outboard motor 60C, the port-side outboard motor 60P and the starboard-side outboard motor 60S, respectively.

The steering wheel 52 is turned by a user (watercraft operator). The operation angle of the steering wheel 52 is detected by an operation angle sensor 53, and inputted to a helm ECU (Electronic Control Unit) 54. The remote controller 55 includes acceleration levers 56 to be operated by the user to adjust the directions (forward or reverse directions) and the magnitudes of propulsive forces to be generated by the respective outboard motors 60. The operation positions of the acceleration levers 56 are respectively detected by acceleration position sensors 57, and inputted to a remote control ECU 58.

The outboard motors 60 each include the engine 61, the propeller 65 that is driven by the engine 61, a shift mechanism 66, and an engine ECU 63. The shift mechanism 66 has a plurality of shift positions, i.e., a forward shift position, a reverse shift position, and a neutral shift position. With the shift position set to the forward shift position, the propeller 65 is rotated in the forward rotation direction by the driving force of the engine 61. With the shift position set to the reverse shift position, the propeller 65 is rotated in a reverse rotation direction by the driving force of the engine 61. With the shift position set to the neutral shift position, power transmission between the engine 61 and the propeller 65 is cut off. The engine ECU 63 controls the operation of a shift actuator 67 that actuates the shift mechanism 66 to control the direction of the propulsive force. Further, the engine ECU 63 controls the operation of a throttle actuator 62 that drives the throttle valve of the engine 61 to control the magnitude of the propulsive force.

The steerings 70 each include a steering actuator 71, and a steering ECU 72 to control the steering actuator 71. The steering actuator 71 generates power to pivot the corresponding outboard motor 60 leftward and rightward about its steering shaft (not shown). Thus, the direction of the propulsive force applied to the hull 51 by the outboard motor 60 is changed leftward and rightward such that the advancing direction of the watercraft 5 is changed. The steering 70 may be unitary with the corresponding outboard motor 60, or may be separate from the outboard motor 60. In FIG. 2, the steering 70 and the outboard motor 60 are configured as a unitary unit by way of example (e.g., the steering 70 is incorporated in the outboard motor 60).

A data communication network, i.e., an onboard network 77, is provided in the watercraft 5. In an example embodiment, the onboard network 77 includes a watercraft control CAN (Control Area Network) 75 and a propulsion device control CAN 76. The onboard network 77 may further include a multiplicity of daughter networks. An onboard system 80 includes the onboard network 77 and various watercraft devices connected to the onboard network 77.

The remote control ECU 58, the helm ECU 54, the engine ECUs 63, and the steering ECUs 72 are connected to the propulsion device control CAN 76. Therefore, an output command from the remote control ECU 58 is transmitted to the engine ECUs 63 via the propulsion device control CAN 76. The output command is a command signal indicating the directions (forward or reverse directions) of the propulsive forces of the respective outboard motors 60. Further, a steering command from the helm ECU 54 is transmitted to the steering ECUs 72 via the propulsion device control CAN 76. The steering command is a command signal corresponding to the operation direction (turning direction) and the operation angle of the steering wheel 52 and indicating the steering directions and the steering angles of the outboard motors 60.

The remote control ECU 58 is also connected to the watercraft control CAN 75. The controller 81 is further connected to the watercraft control CAN 75. Therefore, the controller 81 can acquire information about the output command from the remote control ECU 58.

Further, the controller 81 is able to acquire various information from the watercraft devices connected to the propulsion device control CAN 76, more specifically from the helm ECU 54, the engine ECUs 63, and the steering ECUs 72, via the remote control ECU 58.

Therefore, the controller 81 is able to acquire information about the steering command outputted from the helm ECU 54. Further, the controller 81 is able to acquire, for example, the information about the steering command received by the steering ECUs 72, and information about the detection results of various sensors 73 provided on each of the steerings 70. The sensors 73 include, for example, a steering angle sensor. The steering angle sensor of the steering 70 detects the actual steering angle of the corresponding outboard motor 60. The steering angle sensor may detect the operation amount of the steering actuator 71. Further, the controller 81 can acquire various information from the engine ECUs 63. For example, the controller 81 is able to acquire information about the output command received by the engine ECUs 63, and information about the detection results of various sensors 64 provided on each of the outboard motors 60. The sensors 64 include, for example, a throttle opening degree sensor, an engine speed sensor, and an engine temperature sensor. The throttle opening degree sensor detects the throttle valve opening degree of the engine 61 of the outboard motor 60. The engine speed sensor detects the rotation speed of the engine 61 (engine speed), and may be a crank angle sensor. The engine ECU 63 may be operable to process the output of the crank angle sensor to generate engine speed information. The engine temperature sensor may detect the cylinder block temperature (e.g., coolant temperature) of the engine 61, or may detect the exhaust temperature of the engine 61.

The communication terminal 1 and a gauge 82 to display various information are further connected to the watercraft control CAN 75. The communication terminal 1 is configured or programmed to transmit information about the state of the watercraft 5 and the like to the server 2, more specifically, to transmit configuration information indicating the configuration of the watercraft 5 (particularly, the onboard system 80), failure information indicating a failure occurring in the onboard system 80, the detection values of the sensors, and the like to the server 2 (see FIG. 1).

The gauge 82 functions as a display to display, for example, the residual fuel amount, the engine speeds and the shift positions of the respective outboard motors 60, a residual battery capacity, and the like. The residual battery capacity is the residual capacity of a battery 88 mounted on the hull 51 to actuate starter motors (not shown) incorporated in the respective outboard motors 60 for engine start. The battery 88 discharges for the engine start, and is charged by power generators (not shown) incorporated in the respective outboard motors 60 during the operation of the engines 61. The gauge 82 may include an input device 83 such as input buttons and a touch panel. The input device 83 may be configured to be operated by the user to input various commands. The input device 83 may be provided separately from the gauge 82.

Other various watercraft devices may be connected to the watercraft control CAN 75 in a data communicable manner. Third party watercraft devices are typically connected to the watercraft control CAN 75 via a gateway 84. In FIG. 2, a GPS (Global Positioning System) receiver 85, a fish finder 86, and an autopilot device 87 are shown as examples of third party watercraft devices. The GPS receiver 85 is an example of GNSS (Global Navigation Satellite System) positioning system, which detects the position of the watercraft 5.

The steering wheel 52 and the remote controller 55 are disposed in association with a helm seat, and main switches 78 to be operated to turn on and off power supply to the respective outboard motors 60 and to start and stop the engines 61 of the respective outboard motors 60 are also provided in association with the helm seat. Further, a kill switch 79 (emergency stop switch) to be operated to nullify the propulsive forces of the outboard motors 60 (typically to stop the engines 61) in an emergency is provided in association with the helm seat. The kill switch 79 includes, for example, an operation end to which a lanyard cable carried by the user is connected. When the user falls overboard, the kill switch 79 is actuated for the emergency stop of the engines 61 of the outboard motors 60.

The communication terminal 1 is configured or programmed to be operative while receiving electric power from a communication terminal power supply 89. In an example embodiment, the communication terminal power supply 89 is incorporated in the communication terminal 1, but may be provided outside the communication terminal 1. An example of the communication terminal power supply 89 is a communication terminal battery or a communication terminal capacitor (typically, an electric double layer capacitor). In this case, the communication terminal power supply 89 preferably includes a charging circuit that charges the communication terminal battery or the communication terminal capacitor with the electric power from the battery 88 (main battery). The charging circuit may be configured to stop the charging of the communication terminal battery or the communication terminal capacitor if the voltage of the battery 88 is lower than a predetermined threshold. Another example of the communication terminal power supply 89 is a power supply maintaining circuit. The power supply maintaining circuit may be configured so as not to disconnect the battery 88 from the communication terminal 1 even if the onboard system 80 is out of use.

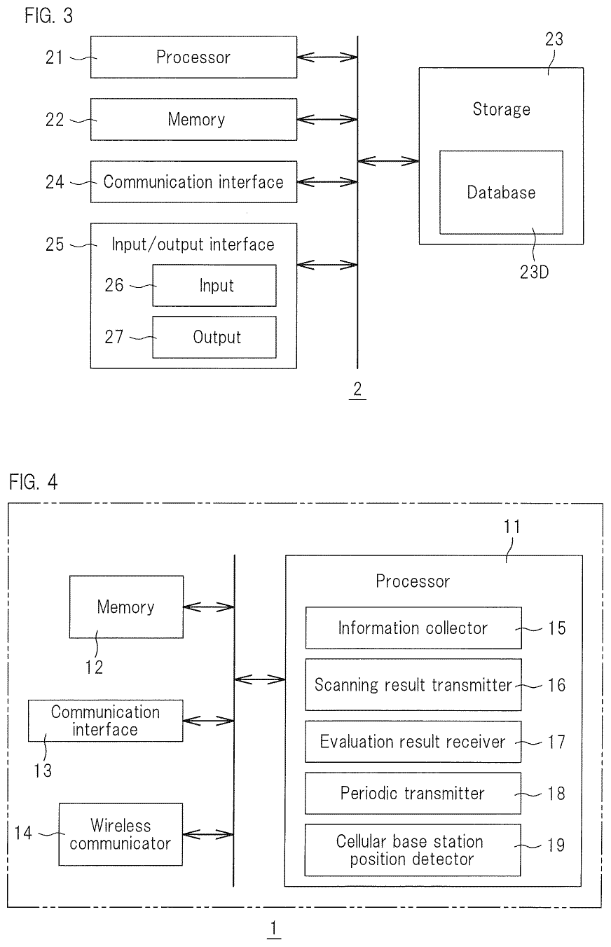

FIG. 3 is a block diagram that describes the configuration of the server 2 by way of example. The server 2 has a basic configuration as a computer. That is, the server 2 includes a processor 21, a memory 22, a storage 23, a communication interface 24 and an input/output interface 25, which are connected to each other in a data communicable manner.

The processor 21 is operative according to a program stored in the memory 22 to perform various functions. Specifically, the server 2 functions to communicate with the communication terminal 1 (see FIG. 1) to collect data from the communication terminal 1 and to accumulate the data in the storage 23. Also, a function of evaluating the onboard system 80 and generating an evaluation result based on the accumulated information is provided. Further, the server 2 functions to communicate with the dealer client 3D (see FIG. 1) to provide a webpage to the dealer client 3D and to provide a web application service on the webpage. A web application program is stored in the memory 22 to provide the web application service. Further, the server 2 functions to communicate with the user client 3U (see FIG. 1) to provide information to an application provided in the user client 3U. The storage 23 provides a storage area for the accumulation of the data. The communication interface 24 interfaces with the network 4 for communications. The input/output interface 25 includes an input device 26 (e.g., a keyboard) and an output device 27 (e.g., a display) to serve as a man-machine interface.

A database 23D is provided in the storage 23 and, for a plurality of watercraft, configuration information indicating the configuration of the onboard system 80 of each individual watercraft is accumulated in the database 23D. The configuration information to be accumulated for the plurality of watercraft 5 includes configuration information transmitted from the communication terminal 1 of the each individual watercraft 5. The configuration information includes information about one or more of the watercraft devices of the onboard system 80. The configuration information about the watercraft devices may include information indicating the types (model names), the component numbers, the serial numbers, the software names, the software versions and the like of the watercraft devices. The configuration information may further include at least one (preferably all) of the number, the layout or the connection states of the watercraft devices. Particularly, the configuration information preferably includes information about the types (model names), the number, the layout or the connection states of the outboard motors 60 as the main devices and the steerings 70 respectively incorporated in the outboard motors 60.

In regard to various watercraft devices that can be installed in the watercraft 5, requirement information (operation conditions) for operating the watercraft devices appropriately within the onboard system 80 is registered in the database 23D. The requirement information includes, for example, hardware requirements and/or software requirements that are essential or allowable for installing each device. The hardware requirements are, for example, requirements (model name, component name, etc.) of other devices that are essential or allowable to be provided inside the onboard system 80 together with each device. The software requirements are, for example, software (software name, software version, etc.) essential or allowable in the other devices provided inside the onboard system 80 together with each device.

Upon receiving the configuration information about the onboard system 80 from the communication terminal 1, the processor 21 searches the database 23D for corresponding requirement information and evaluates the onboard system 80 and develops an evaluation result. More specifically, compatibility of a plurality of watercraft devices of the onboard system 80 is determined and an evaluation result including a system compatibility determination result is generated. When it is confirmed that there is no problem in the compatibility of the plurality of watercraft devices and that all of the watercraft devices operate correctly, the system compatibility determination result becomes “pass.” If there is any problem and there is a possibility for any of the watercraft devices to not operate correctly, the system compatibility determination result becomes “fail.” The processor 21 transmits the system compatibility determination result to the communication terminal 1 via the communication interface 24. If the system compatibility determination result is fail, the processor 21 may generate information about a reason for the failure and/or information about a countermeasure for eliminating the reason for the failure and transmit these information to the communication terminal 1.

Periodic transmission information that is transmitted periodically from the communication terminal 1 of each watercraft 5 is further stored in the database 23D. That is, the processor 21 receives the periodic transmission information and stores it in the database 23D. The processor 21 executes a process using the periodic transmission information. For example, the processor 21 may perform a troubleshooting process using the periodic transmission information. The troubleshooting process typically includes a process to detect an abnormality and preferably further includes a notification process to notify the detected abnormality to the user or the dealer. The notification process may include notification on the webpage provided to the dealer client 3D, and may include a notification on the application of the user client 3U. Further, the notification process may include transmission of an email to a registered email address of the user and/or the dealer. The troubleshooting process may further include an information generation process to be performed to generate information about an abnormality cause identification process to identify the cause of the abnormality and information about an abnormality elimination process to eliminate the abnormality. The information generated by these processes may be covered by the notification processes described above.

The periodic transmission information may include position information. The position information is information indicating a position of the watercraft 5 and a typical example is position information detected by the GPS receiver 85. Another example of the position information is position information about the cellular base station 40 in communication with the communication terminal 1. The periodic transmission information may include operation period information about each outboard motor 60. The operation period information is, in brief, information indicating an operation period of the engine 61 of the outboard motor 60. The operation period information may be a total operation period from start of the engine 61. Also, the operation period information may be a cumulative operation period that is an accumulation of past total operation periods of the engine 61. The position information and/or the operation period information may be transmitted separately from the operation period information from the communication terminal 1 to the server 2.

Information about a distribution stage of the watercraft 5 may further be accumulated in the database 23D. The distribution stage is a stage, such as for example, unshipped, shipment completed, customer delivery completed, etc. Unshipped typically corresponds to a case of being inside a factory of a boatbuilder building the watercraft 5. Shipment completed typically corresponds to a case where shipment from the factory of the boatbuilder has been completed. The watercraft 5 shipped from the boatbuilder is typically supplied to a dealer. Customer delivery completed typically corresponds to a state where the watercraft 5 has been delivered from the dealer to a customer.

Various information can further be registered in the database 23D by the customer operating an application incorporated in the user client 3U. For example, the customer can register information about agreement/disagreement in regard to collecting of accurate position information about the watercraft 5 in the server 2. The accurate position information is specifically the position information generated by the GPS receiver 85.

FIG. 4 is a block diagram showing the configuration of the communication terminal 1 by way of example. The communication terminal 1 includes a processor 11, a memory 12, a communication interface 13, and a wireless communicator 14. The processor 11 is operative according to a program stored in the memory 12 to perform a plurality of functions. The communication interface 13 is configured for data communications via the onboard network 77. The wireless communicator 14 is configured for data communications with the server 2 via the network 4.

The processor 11 performs a data collecting function to collect information from the devices provided on the hull 51 via the onboard network 77 and store the collected information in the memory 12. The information to be collected include the configuration information about the devices (watercraft devices) provided on the hull 51. Further, the information to be collected may include the detection values of the various sensors. Specifically, the processor 11 is able to collect the detection values of the sensors 53, 57, 64, 73 connected to the helm ECU 54, the remote control ECU 58, the steering ECUs 72, and the engine ECUs 63. The information to be collected may further include information generated by the helm ECU 54, the remote control ECU 58, the steering ECUs 72, and the engine ECUs 63. The information may include control information (control commands and other data) to be generated in the respective ECUs, trouble information (error codes) detected by the respective ECUs, and the like. The main switches 78, the kill switch 79, a start switch and other switches are regarded as sensors, and the states of these switches may be collected as the detection values. Further, the processor 11 may have a trouble detection function to monitor the states of the various devices connected to the onboard network 77 and to generate trouble information (failure information). For example, the processor 11 may be operable to monitor the states of the respective ECUs and detect the interruption of the operations of the respective ECUs due to the instantaneous drop of a supply voltage as a trouble (instantaneous power failure). The collected information, the generated trouble information and the like are stored in the memory 12. The processor 11 is not necessarily required to collect information from all the devices connected to the onboard network 77. For example, the processor 11 is not required to cover the third party devices connected to the onboard network 77 via the gateway 84.

The processor 11 functions to transmit a portion or all of the information collected and/or generated by itself and stored in the memory 12 to the server 2 via the wireless communicator 14.

In an example embodiment, the processor 11 functions as an information collector 15 to collect information from the watercraft devices connected to the onboard network 77 via the communication interface 13. One function of the information collector 15 is to perform a system scanning process to collect the configuration information about the watercraft devices connected to the onboard network 77. The processor 11 functions as a scanning result transmitter 16 to perform a scanning result transmission process to cause the wireless communicator 14 to transmit the information collected by the system scanning process as a scanning result to the server 2. The server 2 receives the scanning result, and registers the scanning result as the configuration information about the onboard system 80 in the database 23D. The server 2 further evaluates the onboard system 80 based on the configuration information and transmits the evaluation result to the communication terminal 1. The functions of the processor 11 include a function as an evaluation result receiver 17 that executes an evaluation result receiving process of receiving the evaluation result from the server 2 by the wireless communicator 14. As mentioned above, the evaluation result includes the system compatibility determination result and if the system compatibility determination result is fail, information about the reason therefor and/or the countermeasure against the reason is included.

The processor 11 stores the information collected by the system scanning process as the scanning result in the memory 12. The processor 11 also stores the evaluation result (system compatibility determination result) received from the server 2 in the memory 12.

The processor 11 performs the system scanning process at the startup of the onboard system 80. Further, the processor 11 performs the system scanning process when an additional watercraft device is incorporated into the onboard network 77 to change the configuration of the onboard system 80.

The information collector 15 does not only collect the information by the system scanning process, but also collects various information from the watercraft devices via the onboard network 77 during the operation of the onboard system 80. The processor 11 functions as a periodic transmitter 18 to perform a periodic transmission process to transmit predetermined periodic transmission information to the server 2 at a predetermined periodic transmission interval during the operation of the onboard system 80. The periodic transmission interval may be, for example, about ten minutes. The periodic transmission information includes the information collected by the information collector 15 and includes, for example, operation information indicating the operation states of the outboard motors 60 (propulsion device). The periodic transmission information is uploaded to the server 2 to be accumulated in the database 23D, and is mainly used to later investigate into the presence/absence of any abnormality and a situation in which the abnormality occurs, and the like. In an example embodiment, the operation information includes the operation period information described above.

The periodic transmission information includes an error code as required. Specifically, when an error code indicating the presence of an error at the startup of the onboard system 80 appears on the onboard network 77, the error code is incorporated in the periodic transmission information. Thereafter, if there is any change in the error code during the operation of the onboard system 80, the thus changed error code is incorporated in the periodic transmission information. The transmission of the error code to the server 2 may be performed separately from the periodic transmission process.

Also, the position information described above is included in the periodic transmission information. The communication terminal 1 may acquire the position information from the GPS receiver 85 via the onboard network 77 and include it in the periodic transmission information. Also, the communication terminal 1 includes a function as a cellular base station position detector 19 (cellular base station positioning system) that acquires the position information about the cellular base station 40 with which communication is currently established from the cellular base station 40. The communication terminal 1 may include the acquired position information about the cellular base station as the position information about the watercraft 5 in the periodic transmission information. Based on a command from the server 2 or based on a predetermined determination condition, the communication terminal 1 selects the position information of high precision detected by the GPS receiver 85 or the position information about the cellular base station 40 that is lower in precision and includes the selected position information in the periodic transmission information. The determination condition includes, for example, either or both of a condition regarding the cumulative operation period of the engine 61 or a condition regarding agreement of the customer in regard to acquisition of the accurate position information.

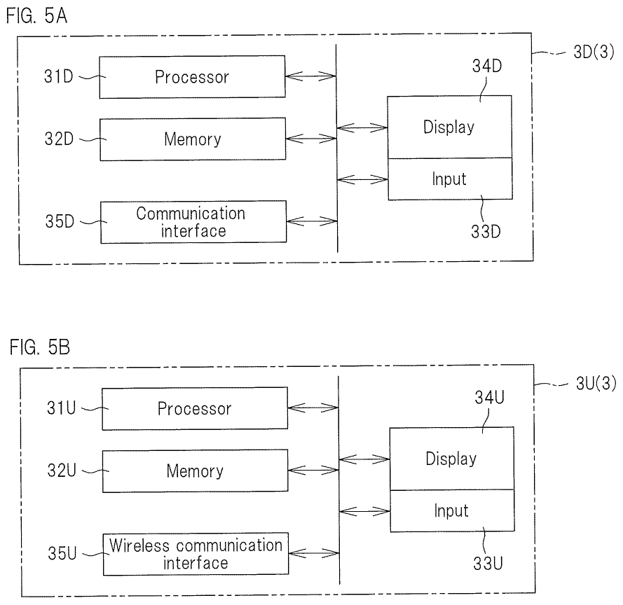

FIG. 5A is a block diagram that describes the configuration of the dealer client 3D by way of example. The dealer client 3D has a basic configuration as a computer. For example, the dealer client 3D may be a personal computer of clamshell type, tablet type, or the like.

The dealer client 3D includes a processor 31D, a memory 32D, an input device 33D, a display 34D, and a communication interface 35D. The processor 31D executes a program stored in the memory 32D to perform various functions. The input device 33D may be a touch panel provided on the display screen of the display 34D. The communication interface 35D interfaces with the network 4 for data communications. The communication interface 35D may communicate with the network 4 (see FIG. 1) via the local area network (not shown) provided in the dealer office, the marina office or the like through cable or wireless data communications. Further, the communication interface 35D may be configured to be connectable to the wireless data communication network 4B (see FIG. 1).

In the memory 32D, at least a web browser program is stored. The processor 31D executes the web browser program such that the user of the dealer client 3D (dealer staff, marina staff or the like) can browse the webpage provided by the server 2 to use the web application service provided on the webpage.

The user of the dealer client 3D can display the webpage on the display 34D. On the webpage thus displayed, the user of the dealer client 3D can receive information from the server 2. Specifically, the configuration information about the customer's watercraft 5 can be acquired and information about a trouble occurring in the customer's watercraft 5 can be acquired.

Further, an email receiving program (mailer) may be stored in the memory 32D. The processor 31D executes the email receiving program such that the user of the dealer client 3D can receive an email transmitted from the server 2. Thus, the notification about the trouble occurring in the customer's watercraft 5, etc., can be obtained from the server 2 by email.

FIG. 5B is a block diagram that describes the configuration of the user client 3U by way of example. The user client 3U has a basic configuration as a computer. More specifically, the user client 3U has a basic configuration as a mobile terminal, still more specifically, has a basic configuration as a smartphone. The user client 3U includes a processor 31U, a memory 32U, an input device 33U, a display 34U, and a wireless communication interface 35U.

The processor 31U executes a program stored in the memory 32U to perform various functions. The input device 33U may be a touch panel provided on the display screen of the display 34U. The wireless communication interface 35U interfaces with the network 4 (more specifically, the wireless data communication network 4B) for data communications. The wireless communication interface 35U may be configured to interface with the onboard network 77 for data communications. In this case, the user client 3U can be connected to the network 4 via the onboard network 77 and the communication terminal 1 to allow data communications with the server 2.

An application program executable by the processor 31U (so-called native application program) is stored in the memory 32U. The processor 31U executes the native application program such that the user of the user client 3U (typically, the user or the owner of the watercraft 5) can acquire the information provided by the server 2 and display the information on the screen of the application program. Specifically, by operation of the application program, information about the state of the watercraft 5 (for example, information about the position, residual fuel amount and trouble of the watercraft 5), etc., can be acquired.

Further, an email receiving program (mailer) may be stored in the memory 32U. The processor 31U executes the email receiving program such that the user of the user client 3U can receive an email transmitted from the server 2. Thus, the notification about the trouble occurring in the customer's watercraft 5, etc., can be obtained from the server 2 by emails.

The user client 3U may include a function of declaring the agreement/disagreement in regard to collecting and accumulating of the accurate position information about the watercraft 5 in the server 2 and registering this in the server 2. Such agreement/disagreement may also be registerable by a method besides using the user client 3U. For example, an arrangement may be made such that a staff of the dealer can register the agreement/disagreement in the server 2 by operating the dealer client 3D in accordance with a wish of the customer.

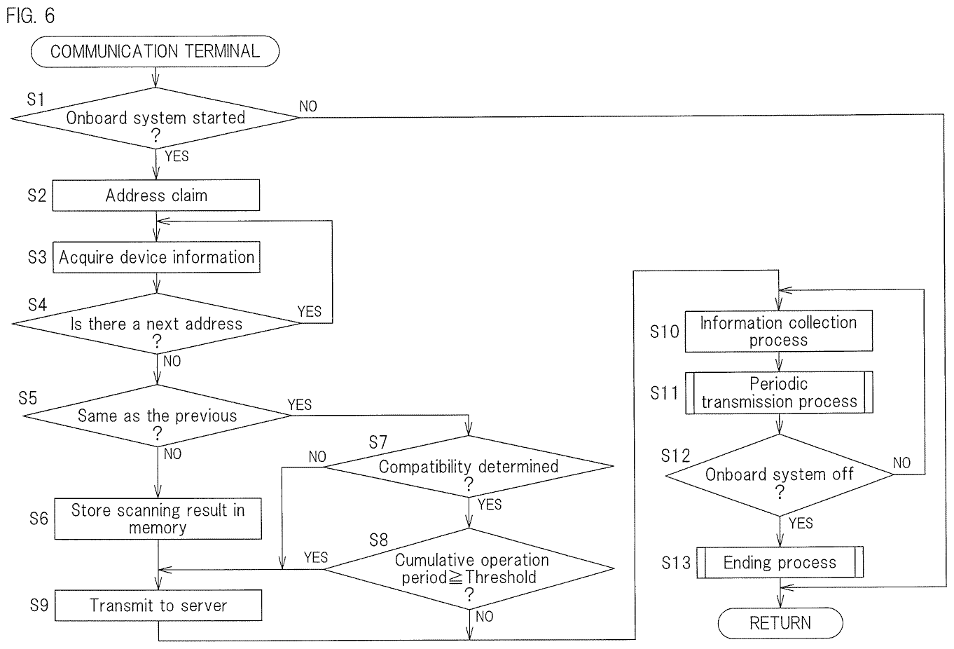

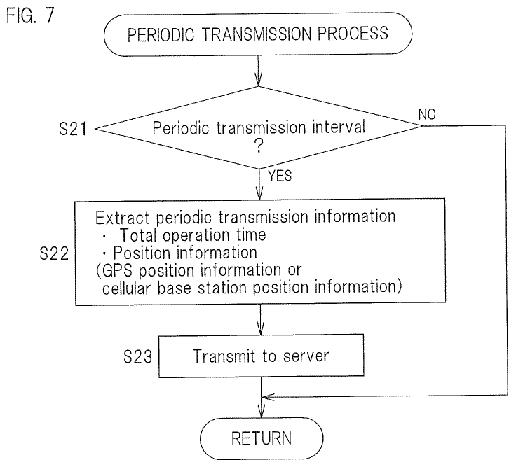

FIG. 6 is a flowchart that describes an exemplary operation to be performed by the communication terminal 1, mainly showing an exemplary process to be periodically performed by the processor 11 (see FIG. 4). The communication terminal 1 monitors the onboard system 80 for startup and, if the onboard system 80 is started (YES in Step S1), the communication terminal 1 performs a watercraft device information acquisition process to acquire information about the watercraft devices connected to the onboard network 77. When a message is outputted from any of the watercraft devices to the onboard network 77, for example, the communication terminal 1 may determine that the onboard system 80 is started. More specifically, when the message appears on the watercraft control CAN 75, the communication terminal 1 may determine that the onboard system 80 is started.

In order to acquire the information about the watercraft devices connected to the onboard network 77, the communication terminal 1 acquires the addresses of the watercraft devices connected to the watercraft control CAN 75 (Step S2). For the acquisition of the addresses, the communication terminal 1 may output an address claim to the onboard network 77 (specifically, to the watercraft control CAN 75) to claim its own address. The watercraft devices connected to the watercraft control CAN 75 are each configured to output an address claim to claim an address to be used in response to the address claim outputted to the watercraft control CAN 75 by the communication terminal 1. Thus, the communication terminal 1 can acquire the addresses of the respective watercraft devices connected to the watercraft control CAN 75 by outputting the address claim to the watercraft control CAN 75.

Next, the communication terminal 1 performs the system scanning process. Specifically, the communication terminal 1 transmits a configuration information transmission request to one of the watercraft devices connected to the onboard network 77 (more specifically, to the watercraft control CAN 75) at any specific one of the acquired addresses. In response to the request, the watercraft device at the specific address transmits its configuration information to the communication terminal 1. The communication terminal 1 receives the configuration information, and stores the received configuration information in the memory 12. Thus, the configuration information about the watercraft device is acquired (Step S3: the function of the information collector 15). This process is performed repeatedly for all the watercraft devices at the acquired addresses (Step S4) such that the configuration information is acquired for all the watercraft devices connected to the onboard network 77.

The remote control ECU 58 collects information from the watercraft devices (the helm ECU 54, the engine ECUs 63, and the steering ECUs 72) connected to the propulsion device control CAN 76. That is, upon reception of the configuration information transmission request, the remote control ECU 58 does not only transmit its configuration information to the communication terminal 1, but also collects configuration information about the watercraft devices connected to the propulsion device control CAN 76 and transmits the collected configuration information to the communication terminal 1. Thus, the configuration information is collected for all the watercraft devices connected to the onboard network 77. The configuration information thus acquired by the system scanning process is the scanning result, and data indicating the scanning result is referred to as “scanning result data.” The configuration information about the communication terminal 1 itself is also included as the scanning result data.

The communication terminal 1 reads out previous scanning result data from the memory 12, and compares new (latest) scanning result data with the previous scanning result data to determine whether the new scanning result and the previous scanning result are consistent or inconsistent with each other (Step S5). If the previous scanning result data is not stored in the memory 12, the result of the determination is inconsistent. If the new scanning result is inconsistent with the previous scanning result (NO in Step S5), the communication terminal 1 stores the new scanning result data in the memory 12 (Step S6), and transmits the new scanning result data to the server 2 (Step S9: the function of the scanning result transmitter 16).

On the other hand, if the new scanning result and the previous scanning result are consistent with each other (YES in Step S5), the communication terminal 1 checks whether or not data indicating the system compatibility determination result (system compatibility determination result data) is stored in the memory 12. If the system compatibility determination result data is stored in the memory 12 and the system compatibility determination result indicates pass (YES in Step S7), the communication terminal 1 does not transmit the scanning result data to the server 2. That is, if it has been determined that the compatibility of the watercraft devices of the onboard system 80 is correct, the onboard system 80 is constructed appropriately and therefore, the communication terminal 1 does not send the scanning result data to the server 2. In this case, the communication terminal 1 also does not need to store the new scanning result data in the memory 12. Obviously, it is allowable to store the new scanning result data in the memory 12.

However, in an example embodiment, there is a case where the latest scanning result is transmitted to the server 2 even if the new scanning result and the previous scanning result are consistent with each other (YES in Step S5) and the correctness determination of the compatibility of the watercraft devices is completed (YES in Step S7). Specifically, the communication terminal 1 determines the cumulative operation period (cumulative total of total operation periods) of the outboard motor 60 and compares the cumulative operation period with a predetermined threshold (Step S8). If the cumulative operation period is less than the threshold (NO in Step S8), the communication terminal 1 does not execute the transmission of the scanning result data to the server 2. If the cumulative operation period has reached the threshold (YES in Step S8), the communication terminal 1 transmits the latest scanning result data to the server 2 (Step S9). The predetermined threshold is preferably set, in consideration of a test operation, etc., to a value (for example, approximately 10 hours) at which the delivery of the watercraft 5 to the customer is considered to have been completed. The configuration information about the onboard system 80 in the state of having been delivered to the customer can be transmitted to and accumulated in the server 2. In the watercraft 5 in which the plurality of outboard motors 60 are installed, a maximum value among the cumulative operation periods of the engines 61 of the plurality of outboard motors 60 and the threshold may be compared in Step S8.

On the other hand, the communication terminal 1 collects the information transmitted from the watercraft devices to the onboard network 77 during the operation of the onboard system 80, and stores the collected information in the memory 12 (Step S10, the function of the information collector 15). Then, the communication terminal 1 performs the periodic transmission process to periodically transmit predetermined periodic transmission information out of the collected information (Step S11: the function of the periodic transmitter 18).

The communication terminal 1 monitors whether or not the use of the onboard system 80 is continued, i.e., whether or not the onboard system 80 is in operation (Step S12). If the onboard system 80 is in operation, the information collection process (Step S10) and the periodic transmission process (Step S11) are continued. If the termination of the use of the onboard system 80 is detected (YES in Step S12), the communication terminal 1 performs the termination process (Step S13). The termination process may include a transition to a sleep mode (energy saving mode).

Whether or not the onboard system 80 is in operation (in use) can be detected (Step S12), for example, by monitoring the information periodically appearing on the onboard network 77. For example, when the power supply to the onboard system 80 is on, the engine ECUs 63 are in operation to periodically output the engine speed data to the onboard network 77. Therefore, if no engine speed data appears on the onboard network 77 for longer than the predetermined period of time, the communication terminal 1 may determine that the use of the onboard system 80 is terminated.

Although unillustrated, upon receiving the system compatibility determination result data from the server 2, the communication terminal 1 stores the data in the memory 12 (the function of the evaluation result receiver 17). The communication terminal 1 further transmits the system compatibility determination result data to the gauge 82. The gauge 82 displays the system compatibility determination result on the screen. For example, immediately after the onboard system 80 is constructed and immediately after a change is applied to the onboard system 80, the gauge 82 displays that the system scanning process is unfinished. This display may be a popup display of a message: “Please execute system scanning process.” Such a display is mainly intended to transmit information to working staff of the boatbuilder or the dealer. The gauge 82 continues the display until the system compatibility determination result data indicating pass is written in.

If the communication terminal 1 writes the system compatibility determination result data, received from the server 2, into the gauge 82 and the system compatibility determination result data indicates pass, the gauge 82 erases the abovementioned display (for example, the popup display). On the other hand, if the system compatibility determination result data indicates fail, the gauge 82 displays that this is so. If the system compatibility determination result data includes information indicating a causing reason for the failure and/or a countermeasure against the causing reason, the information may be displayed additionally.

The boatbuilder or the dealer is provided with a specialized service tool for diagnosis of the onboard system 80. The specialized service tool is typically a personal computer and functions as a diagnostic device by operation of a specialized application. By connecting the specialized service tool to the onboard network 77, the system scanning process such as described above can be performed using the specialized service tool. The specialized service tool further includes a communication function of communicating with the server 2. Therefore, by using the specialized service tool, the system scanning process, the transmission of the scanning result to the server 2, and the receiving of the system compatibility determination result can be performed as with the communication terminal 1. The specialized service tool may have not just this function but also, for example, a function of downloading the latest software for the watercraft devices from the server and installing it in the corresponding watercraft devices.

FIG. 7 is a flow chart that describes an example of the periodic transmission process (Step S11 in FIG. 6) to be performed by the communication terminal 1 when the onboard system 80 is in operation. In every periodic transmission interval (occurring, for example, at a periodic transmission interval of 10 minutes) (YES in Step S21), the communication terminal 1 transmits the periodic transmission information to the server 2. More specifically, from the information stored in the memory 12 by the information collection process (Step S10 in FIG. 6), predefined information classified as the periodic transmission information is extracted (Step S22), and the extracted information is transmitted as the periodic transmission information to the server 2 (Step S23).

The periodic transmission information includes the operation information of the outboard motors 60, more specifically, engine operation information. The engine operation information includes, for example, information about engine operation periods for a plurality of predefined engine speed ranges, information about the total operation period from engine start, etc. The engine operation information may further include an over-revolution count, an overheat count, a lower oil pressure count, a knocking control count, a reverse rotation count, and the like. The periodic transmission information may further include information about the detection values of the various sensors. The communication terminal 1 periodically collects the engine operation information and the detection values of the sensors from the watercraft devices via the onboard network 77 (Step S10 in FIG. 6). A periodic collection interval for the periodic collection is shorter than the periodic transmission interval.

In an example embodiment, the periodic transmission information includes the position information. The position information is the accurate position generated by the GPS receiver 85 or the position information about the cellular base station with which communication with the communication terminal 1 is established (approximate position information). A command from the server 2 is followed in regard to which of the position information is to be selected. In an initial state of the communication terminal 1, the command from the server 2 is unreceived and therefore, the accurate position information generated by the GPS receiver 85 may be set to be transmitted as a default option to the server 2.

Also, when the onboard system 80 is shut down, the communication terminal 1 enters a sleep mode (Step S13 of FIG. 6) and does not perform the periodic transmission process while in the sleep mode. However, even while in the sleep mode, the communication terminal 1 may, for example, communicate with the server 2 and perform transmission of the position information to the server 2 at an interval greater than or equal to the periodic transmission interval.

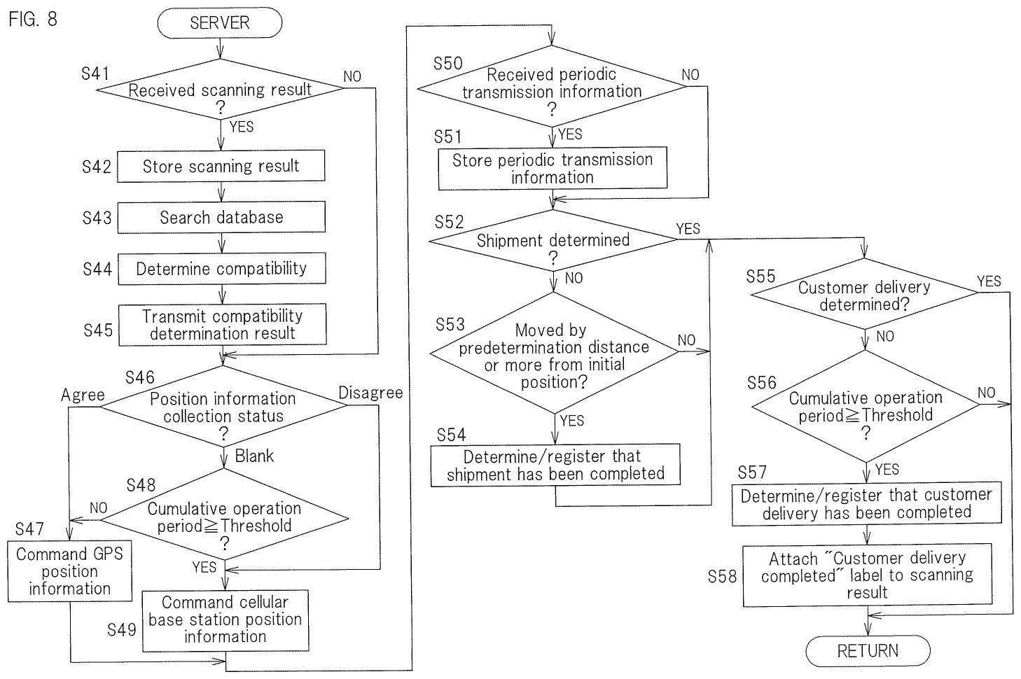

FIG. 8 is a flowchart that describes an exemplary process to be performed by the server 2, mainly showing a process to be periodically performed by the processor 21 (see FIG. 3). The server 2 receives the scanning result data from the communication terminal 1 of the watercraft 5 (Step S41), and accumulates the received scanning result data in the storage 23 (Step S42).

For each watercraft device, the requirement information stating the requirements for appropriate operation is stored in the database 23D constructed inside the storage 23. The requirement information typically includes essential requirement information stating an essential requirement for making the device operate appropriately. The requirement includes, for example, information about other watercraft devices that should be included in the same onboard system and information about the software of such watercraft devices.

The server 2 searches the database 23D based on the scanning result data (Step S43). The server 2 then judges whether or not the requirement information about the respective watercraft devices is satisfied and determines whether the compatibility of the plurality of watercraft devices of the onboard system 80 passes or fails (Step S44). The determination result is transmitted as the system compatibility determination result data to the communication terminal 1 (Step S45).

If the compatibility determination is fail, the server 2 preferably specifies the failed requirement information and transmits the requirement information as failure reason information to the communication terminal 1. The failure reason information may include information about a countermeasure for eliminating the reason in place of the information about the reason for failure or in addition to the information about the reason for failure. As mentioned above, the reason for failure and/or the countermeasure therefor may be displayed on the gauge 82 of the onboard system 80. For example, a message such as: “The ROM information about the engine ECU is old. Please update the ECU.” may be displayed on the gauge 82.

Also, when a new software is available for use in any of the watercraft devices of the onboard system 80, the server 2 may notify this to the communication terminal 1. In this case, the server 2 preferably determines in advance that the compatibility determination will be passed even when the new software is incorporated. Upon receiving the notification that the new software is available for use, the communication terminal 1 preferably displays this on the gauge 82. The user or a worker can be urged to use the new software.

Incorporation (installation) of the new software in the watercraft device can be performed by connecting the specialized service tool to the onboard network 77. The communication terminal 1 may have a function of downloading the new software from the server 2. And, for example, the gauge 82 and the input device 83 may be arranged to be used as man-machine interfaces to enable performing an incorporation operation (installation operation) of the software in the corresponding watercraft device.

Also, the server 2 registers, in the database 23D, a status regarding agreement of collection of the accurate position information for each watercraft 5. The status is, for example, any of “Agree” that indicates that the customer has agreed to the collection of the accurate position information, “Disagree” that indicates that the customer has not agreed to the collection of the accurate position information, and “Blank” that indicates that the customer has not answered. The server 2 checks this status (Step S46) and if it is “Agree,” commands the communication terminal 1 to add the latest position information generated by the GPS receiver 85 (GPS position information) to the periodic transmission information (Step S47). If the status is “Disagree,” the server 2 commands the communication terminal 1 to acquire the position information about the cellular base station 40 with which communication is currently established (cellular base station position information) from the cellular base station 40 and add the information to the periodic transmission information (Step S49). If the status is “Blank,” the server 2 further performs a determination based on the cumulative operation period (Step S48). The cumulative operation period refers to the cumulative total of total operation periods that the communication terminal 1 acquires from the engine ECU 63 and transmits to the server 2. That is, it is the cumulative total of operation periods of the outboard motor 60 since the onboard system 80 was constructed. In the watercraft 5 provided with the plurality of outboard motors 60, the maximum value of the cumulative operation periods of the engines 61 of the plurality of outboard motors 60 may be used. The server 2 computes the cumulative operation period and compares it with the predetermined threshold (for example, 10 hours). That is, when the status is “Blank,” the cumulative operation period and the threshold are compared and if the cumulative operation period is less than the threshold, (NO in Step S48), the server 2 commands the communication terminal 1 to add the GPS position information to the periodic transmission information (Step S47). On the other hand, if when the status is “Blank,” the cumulative operation period is greater than or equal to the threshold (YES in Step S48), the server 2 commands the communication terminal 1 to add the cellular base station position information to the periodic transmission information (Step S49). The comparison of the cumulative operation period and the threshold is performed to judge whether or not the delivery of the watercraft 5 to the customer has been completed. By setting the threshold appropriately, whether or not the delivery of the watercraft 5 to the customer has been completed can be judged based on the cumulative operation period and the appropriate position information can be selected and transmitted to the server 2 based on the judgment result.

Also, the server 2 receives the periodic transmission information from the communication terminal 1 (Step S50) and registers the received periodic transmission information in the database 23D (Step S51). For example, the server 2 executes the troubleshooting process based on the information registered in the database 23D. If an abnormality is found by the troubleshooting process, the server 2 may execute an abnormality notification process to notify the abnormality. The abnormality notification process may include one or more of the display on the webpage provided by the server 2, the notification by the application of the user client 3U, and the transmission of an email to the dealer or the user (or the owner).

The server 2 also performs a distribution stage specifying process (Steps S52 to S57: function as a distribution stage specifier) for specifying the distribution stage of the watercraft 5. Specifically, the server 2 executes a shipment determining process (Steps S52 to S54: function as a shipment determiner) and a customer delivery determining process (Steps S55 to S57: function as a customer delivery determiner).

When the shipment determining process is unfinished (NO in Step S52), the server 2 compares an initial position indicated by the position information when the first system scanning process was performed in the watercraft 5 and a current position indicated by the latest position information received from the communication terminal 1 thereafter (Step S53). Then, if the current position is separated from the initial position by a predetermined distance (for example, several kilometers) or more (YES in Step S53), the server 2 determines that the watercraft 5 has been shipped and registers distribution stage data indicating “Shipment completed” in the database 23D (Step S54). The GPS receiver 85 that is one of the watercraft devices of the onboard system 80 detects the position of the onboard system 80, that is, the position of the watercraft 5. A location where the communication terminal 1 executes the system scanning process for the first time is a location where the onboard system 80 is constructed, that is, a location where the watercraft 5 is built and is typically the factory of the boatbuilder. Thus, when a movement by the predetermined distance (for example, several kilometers) from the initial position (the factory of the boatbuilder) detected by the GPS receiver 85 when the system scanning process is executed for the first time is detected, it can be determined that the watercraft 5 has been shipped from the boatbuilder.

When the customer delivery determination is unfinished (NO in Step S55), the server 2 executes the customer delivery determining process. The customer delivery determining process is performed based on the cumulative operation period. That is, the server 2 accumulates the total operation periods received from the communication terminal 1 and determines the cumulative operation period. The cumulative operation period is compared with a predetermined threshold (for example, 10 hours) (Step S56). If the cumulative operation period is less than the predetermined threshold (NO in Step S56), the server 2 determines that delivery to the customer is yet to be performed. When the cumulative operation period reaches the predetermined threshold (YES in Step S56), the server 2 determines that the delivery of the watercraft 5 to the customer has been completed and registers distribution stage data indicating “Customer delivery completed” in the database 23D (Step S57). Until the watercraft 5 is delivered to the customer upon being built, test operation of the outboard motor 60 (in particular, the engine 61) is executed as necessary. Obviously, this operation period is a short period compared to an operation period from start of use upon delivery to the customer. Thus, when the cumulative operation period of the outboard motor 60 exceeds the predetermined threshold (for example, 10 hours), it can be determined that the watercraft 5 has been delivered to the customer. In the watercraft 5 in which the plurality of outboard motors 60 are installed, the customer delivery determination may be performed by comparing the maximum value among the cumulative operation periods of the engines 61 of the plurality of outboard motors 60 and the threshold.

As mentioned above, when the cumulative operation period of the outboard motor 60 reaches the predetermined threshold (for example, 10 hours) (YES in Step S8 of FIG. 6), the communication terminal 1 transmits the latest scanning result data to the server 2 (Step S9 of FIG. 6) and the server 2 receives and registers the data in the database 23D (Steps S41 to S42 of FIG. 8). The transmission and registration of the latest scanning result data in this case is performed even if the data is consistent with the immediately previous scanning result data (YES in Step S5 of FIG. 6) or even if the compatibility determination is unfinished (YES in Step S7 of FIG. 6). Then, upon determining that the watercraft 5 has been delivered to the customer when the cumulative operation period of the outboard motor 60 reaches the predetermined threshold (for example, 10 hours), the server 2 attaches a “Customer delivery completed” label to the latest scanning result data of the watercraft 5 (Step S58 of FIG. 8).

As described above, in an example embodiment, the onboard system 80 is configured by connecting the plurality of watercraft devices to the onboard network 77. The communication terminal 1 is communicable with the other watercraft devices via the onboard network 77, and is communicable with the server 2 provided outside the watercraft 5. In an example embodiment, the communication terminal 1 performs the system scanning process to collect the information about the watercraft devices, and transmits the scanning result to the server 2. Therefore, the system scanning process can be performed and the evaluation result of the system scanning process can be acquired even without connecting the specialized service tool, which is not an element of the onboard system 80, to the onboard network 77. Therefore, if the onboard system 80 is constructed appropriately and accordingly, the evaluation of the scanning result is satisfactory, a diagnostic task performed by connecting the specialized service tool can be omitted. Labor and time for diagnosis of the onboard system 80 can be reduced.

In an example embodiment, besides registering the scanning result received from the communication terminal 1, the server 2 further collects the position information about the watercraft 5 and the information about the distribution stage of the watercraft 5. The position information about the watercraft 5 can be used, for example, to specify a region in which the watercraft 5 is actually used and can therefore be used as reference information for development and design of the watercraft devices. The information about the distribution stage can be used, for example, as reference information for production management and distribution management of the watercraft devices.

In an example embodiment, specifying of the distribution stage is performed by the server 2.

Specifically, the server 2 uses the position information received from the communication terminal 1 and if it detects a movement by the predetermined distance (for example, several kilometers) from the initial position (the factory of the boatbuilder) when the first system scanning process is executed, it determines that the watercraft 5 has been shipped from the boatbuilder. The server 2 registers “Shipment completed” as the distribution stage data in the database 23D. This registered distribution stage data can be viewed, for example, by using the dealer client 3D. The dealer can know that the shipment of the watercraft 5 has been completed. The server 2 may, for example, perform a notification process to notify “Shipment completed” to the dealer. The notification process may be a notification on a webpage provided by the server 2 or may be an email transmission to the dealer.

Also in an example embodiment, the server 2 uses the operation period information acquired from the communication terminal 1 and if the cumulative operation period of the outboard motor 60 exceeds the predetermined threshold (for example, 10 hours), it determines that the watercraft 5 has been delivered to the customer and registers “Customer delivery completed” as the distribution stage data in the database 23D. This registered distribution stage data may be used, for example, for the purpose of confirmation, etc., by a maker of the outboard motor 60 or other watercraft device. For example, by examining the scanning result data of the watercraft 5 for which customer delivery has been completed, the maker of the watercraft device can confirm whether or not the delivery to the customer has been performed in the state in which the onboard system 80 has been constructed appropriately. For example, it can be confirmed whether or not the delivery to the customer has been performed in the state where the latest software has been introduced in the watercraft device.

In an example embodiment, the communication terminal 1 stores the scanning result in the memory 12 (example of a scanning result memory). The communication terminal 1 compares the new scanning result that is the information collected anew by the system scanning process and the previous scanning result stored in the memory 12. And if the new scanning result and the previous scanning result are inconsistent with each other, the new scanning result is transmitted to the server 2 and the server 2 executes the evaluation of the new scanning result. On the other hand, if the new scanning result and the previous scanning result are consistent with each other, the scanning result transmission process is omitted and therefore, the evaluation of the scanning result by the server 2 is also not executed. The diagnostic task performed by connecting the specialized service tool can thus be lightened while lightening the loads on the communication terminal 1 and the server 2.

Also, the communication terminal 1 stores the evaluation result received from the server 2 in the memory 12 (example of an evaluation result memory). When an evaluation result is not stored in the memory 12, the communication terminal 1 executes the scanning result transmission process regardless of whether or not the information collected anew by the system scanning process and the previous information stored in the memory 12 are consistent with each other. The evaluation of the scanning result by the server 2 can be prevented from remaining unfinished. Whether or not the onboard system 80 is constructed appropriately can therefore be evaluated without fail.

In an example embodiment, the server 2 determines the compatibility of the plurality of watercraft devices and generates and transmits the evaluation result that includes the determination result (system compatibility determination result) to the communication terminal 1. Since the compatibility of the plurality of watercraft devices of the onboard system 80 is evaluated, it can be judged, based on the evaluation result, whether or not the respective watercraft devices will operate appropriately.

Also, in an example embodiment, when the cumulative operation period of the outboard motor 60 exceeds the predetermined threshold, the communication terminal 1 transmits, to the server 2, the latest scanning result regardless of whether or not it is consistent with the previous scanning result. Information about the watercraft devices at the point at which the cumulative operation period of the outboard motor 60 exceeds the threshold can be acquired by the server 2. By setting the threshold to an appropriate value (for example, approximately 10 hours), the server 2 can acquire information about the watercraft devices after the watercraft 5 has been delivered to the customer. By examining this, it can be confirmed whether or not the watercraft 5 of an appropriately configured state has been delivered to the customer.

Also, in an example embodiment, the server 2 attaches the label identifying the distribution stage to the scanning result received from the communication terminal 1. More specifically, the “Customer delivery completed” label is attached to the latest scanning result data. Thus, by searching using the label as a key, the scanning result of the watercraft 5 for which delivery to the customer has been completed can be extracted and examined.

Also, in an example embodiment, either the accurate position information generated by the GPS receiver 85 (GPS position information) or the position information about the cellular base station position with which communication with the communication terminal 1 is established (cellular base station position information) is collected in the server 2 based on the predetermined determination condition. Specifically, when the status of the agreement of the customer in regard to the collection of the accurate position information is “Agree,” the GPS position information is collected and when the status is “Disagree,” the cellular base station position information is collected. The collection of the position information can thus be performed appropriately while respecting the customer's wishes. Further, when the status is “Blank” (unanswered), the GPS position information is collected if the cumulative operation period of the outboard motor 60 is less than the predetermined threshold and the cellular base station position information is collected when the cumulative operation period of the outboard motor 60 reaches the threshold. By setting the threshold to an appropriate value (for example, approximately 10 hours), the accurate position information can be collected before delivery to the customer and, on the other hand, the position information of low precision can be collected after delivery to the customer.

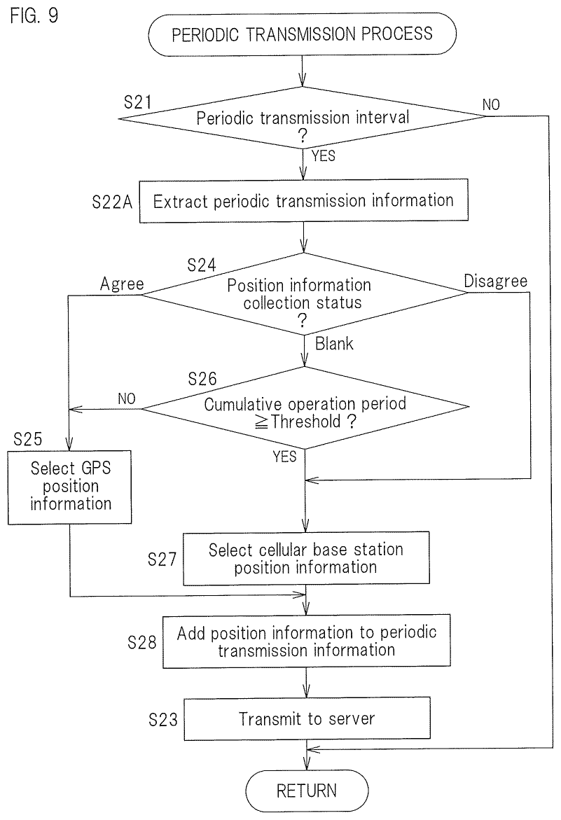

FIG. 9 is a diagram that describes a second example embodiment of the present invention and shows another example of a periodic transmission process to be performed by the communication terminal 1. Whereas in an example embodiment described above, the judgment as to which of the GPS position information and the cellular base station position information is to be collected is made by the server 2, this judgment may be made by the communication terminal 1 instead. FIG. 9 shows an example of the process at the communication terminal 1 in this case.

In every periodic transmission interval (occurring, for example, at a periodic transmission interval of 10 minutes) (YES in Step S21), the communication terminal 1 transmits the periodic transmission information to the server 2. More specifically, from the information stored in the memory 12 by the information collection process (Step S10 in FIG. 6), the predefined information classified as the periodic transmission information is extracted from the information stored in the memory 12 (Step S22A), and the extracted information is transmitted as the periodic transmission information to the server 2 (Step S23, the function of the periodic transmitter 18).

While communication with the server 2 is established, the information about the status regarding the agreement on collection of the accurate position information is provided to the communication terminal 1 from the server 2. The server 2 provides, to the communication terminal 1, the status when the communication with the communication terminal 1 is established for the first time and thereafter provides the latest status information to the communication terminal 1 when the registration of the status is renewed. The communication terminal 1 may also request the transmission of the status information while the communication with the server 2 is established.

The communication terminal 1 checks the status (Step S24) and if it is “Agree,” selects the latest position information generated by the GPS receiver 85 (GPS position information) for the periodic transmission information (Step S25) and adds the position information to the periodic transmission information (Step S28). If the status is “Disagree,” the communication terminal 1 selects the position information about the cellular base station 40 with which communication is currently established (cellular base station position information) (Step S27) and adds the position information to the periodic transmission information (Step S28). If the status is “Blank,” the communication terminal 1 further performs the determination based on the cumulative operation period (Step S26). The communication terminal 1 computes the cumulative operation period and compares it with the predetermined threshold (for example, 10 hours). That is, when the status is “Blank,” the cumulative operation period and the threshold are compared and if the cumulative operation period is less than the threshold (NO in Step S26), the communication terminal 1 selects the GPS position information (Step S25) and adds it to the periodic transmission information (Step S28). On the other hand, when the status is “Blank,” the cumulative operation period is greater than or equal to the threshold (YES in Step S26), the communication terminal 1 selects the cellular base station position information (step S27) and adds it to the periodic transmission information (Step S28). In the watercraft 5 in which the plurality of outboard motors 60 are installed, the judgment of step S26 may be performed using the maximum value among the cumulative operation periods of the engines 61 of the plurality of outboard motors 60.

As in a case described above, the comparison of the cumulative operation period and the threshold is performed to judge whether or not the delivery of the watercraft 5 to the customer has been completed. By setting the threshold appropriately, whether or not the delivery of the watercraft 5 to the customer has been completed can be judged based on the cumulative operation period and the appropriate position information can be selected and transmitted to the server 2 based on the judgment result.

Besides such a process, both the GPS position information and the cellular base station position information may be transmitted from the communication terminal 1 to the server 2 and the server 2 may perform the determination based on the predetermined determination condition (see Steps S46 to S49 of FIG. 8) and select and collect either position information. Also, the transmission process of the position information from the communication terminal 1 to the server 2 may be performed separately of the periodic transmission process.

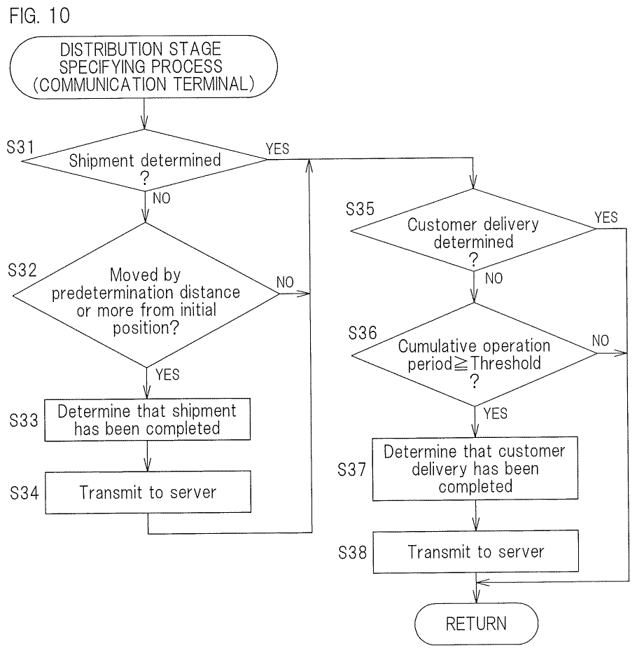

FIG. 10 is a diagram that describes a third example embodiment of the present invention and shows an example where a distribution stage specifying process is executed by the communication terminal 1. Although in the example embodiments described above, the distribution stage specifying process (Steps S52 to S57 of FIG. 8) is executed by the server 2, this process may instead be performed by the communication terminal 1, the data of the specified distribution stage may be transmitted from the communication terminal 1 to the server 2, and the data may be registered in the database 23D by the server 2. A process example at the communication terminal 1 in this case is shown in FIG. 10 and mainly the process (the function as the distribution stage specifier) executed by the processor 11 is shown.

The distribution stage specifying process executed by the communication terminal 1 includes the shipment determining process (Steps S31 to S33: the function as the shipment determiner) and the customer delivery determining process (Steps S35 to S37: the function as the customer delivery determiner).

When the shipment determining process is unfinished (NO in Step S31), the communication terminal 1 compares the initial position indicated by the position information when the first system scanning process was performed in the watercraft 5 and the current position indicated by the latest position information generated by the GPS receiver 85 thereafter (Step S32). Then if the current position is separated from the initial position by the predetermined distance (for example, several kilometers) or more (YES in Step S32), the communication terminal 1 determines that the watercraft 5 has been shipped (Step S33) and transmits the distribution stage data indicating “Shipment completed” to the server 2 (Step S34).

When the customer delivery determination is unfinished (NO in Step S35), the communication terminal 1 executes the customer delivery determining process. The customer delivery determining process is performed based on the cumulative operation period. That is, the communication terminal 1 accumulates the total operation periods acquired from the engine ECU 63 and determines the cumulative operation period. The cumulative operation period is compared with the predetermined threshold (for example, 10 hours) (Step S36). If the cumulative operation period is less than the predetermined threshold (NO in Step S36), the communication terminal 1 determines that the delivery to the customer is yet to be performed. When the cumulative operation period reaches the predetermined threshold (YES in Step S36), the communication terminal 1 determines that the delivery of the watercraft 5 to the customer has been completed (Step S37) and transmits the distribution stage data indicating “Customer delivery completed” to the server 2 (Step S38). In the watercraft 5 in which the plurality of outboard motors 60 are installed, the customer delivery determination may be performed by comparing the maximum value among the cumulative operation periods of the plurality of outboard motors 60 and the threshold.

While some example embodiments of the present invention have thus been described above, the present invention may be embodied in yet other ways as described exemplarily below.

For example, in the aforementioned example embodiments, the outboard motors are used as the propulsion device by way of example, but the propulsion device provided on the watercraft may be in any of various types such as inboard motors, inboard/outboard motors and waterjet propulsion devices.

Also, although description was omitted with the example embodiments described above, the communication between the communication terminal 1 and the server 2 may be performed via one or more relay servers. Although in this case, the collection or use of the position information may be performed by any of the relay servers, the propriety of the collection or use of the position information in this case is preferably in accordance with the determination condition such as described above (see Steps S46 to S49 of FIG. 8).

Also, the agreement of the customer in regard to the collection of the accurate position information may be arranged to be registered as a temporary agreement status in the server 2 for the purpose of inspection, etc., before delivery to the customer. Preferably in this case, the temporary agreement is registered, for example, as a status with a predetermined time limit and the status is changed to blank upon arrival of the time limit.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft information collecting system comprising:
an onboard system including a plurality of watercraft devices on a watercraft, an onboard network on the watercraft and connected to the plurality of watercraft devices, and a communication terminal communicable with the plurality of watercraft devices via the onboard network; and
a server outside the watercraft and communicable with the communication terminal; wherein
the communication terminal is configured or programmed to execute a system scanning process to collect information about the plurality of watercraft devices and a scanning result transmission process to transmit a scanning result including the information collected by the system scanning process to the server; and
the server is configured or programmed to register the scanning result received from the communication terminal and to collect at least one of position information about the watercraft or information about a distribution stage of the watercraft.

2. The watercraft information collecting system according to claim 1, further comprising:
a distribution stage specifier to specify the distribution stage of the watercraft; wherein
the server is configured or programmed to collect information about the distribution stage specified by the distribution stage specifier.

3. The watercraft information collecting system according to claim 2, wherein
the plurality of watercraft devices include a positioning system; and
the distribution stage specifier includes a shipment determiner to determine that the watercraft has been shipped when the positioning system detects a position separated by a predetermined distance or more from an initial position detected by the positioning system when the communication terminal executes the system scanning process for a first time.

4. The watercraft information collecting system according to claim 3, wherein the communication terminal is configured or programmed to execute a position information transmission process to transmit the position information detected by the positioning system to the server, and the server is configured or programmed to execute the function of the shipment determiner.

5. The watercraft information collecting system according to claim 3, wherein the communication terminal is configured or programmed to acquire the position information detected by the positioning system and to execute the function of the shipment determiner.

6. The watercraft information collecting system according to claim 2, wherein
the plurality of watercraft devices include a propulsion device; and
the distribution stage specifier includes a customer delivery determiner to determine that the watercraft has been delivered to a customer when a cumulative operation period of the propulsion device exceeds a predetermined threshold.

7. The watercraft information collecting system according to claim 6, wherein
the communication terminal is configured or programmed to execute an operation period information transmission process to transmit operation period information about the propulsion device to the server; and
the server is configured or programmed to execute the function of the customer delivery determiner.

8. The watercraft information collecting system according to claim 6, wherein the communication terminal is configured or programmed to acquire the operation period information about the propulsion device and to execute the function of the customer delivery determiner.

9. The watercraft information collecting system according to claim 1, wherein
the communication terminal is configured or programmed to compare the scanning result of a previous system scanning process and the scanning result of a latest system scanning process, not to execute the scanning result transmission process when the two scanning results are consistent with each other, and to execute the scanning result transmission process when the two scanning results are inconsistent with each other;
the plurality of watercraft devices include a propulsion device; and
when a cumulative operation period of the propulsion device exceeds a predetermined threshold, the communication terminal is configured or programmed to transmit a latest scanning result to the server regardless of consistency/inconsistency with the previous scanning result.

10. The watercraft information collecting system according to claim 1, wherein the server is configured or programmed to attach a label to identify the distribution stage to the scanning result received from the communication terminal.

11. The watercraft information collecting system according to claim 1, wherein
the plurality of watercraft devices include a propulsion device, a GNSS (global navigation satellite system) positioning system, and a cellular base station positioning system;
based on a predetermined determination condition, position information generated by either of the GNSS positioning system and the cellular base station positioning system is selected and accumulated in the server; and
the determination condition includes at least one of a condition regarding the operation period of the propulsion device or a condition regarding an agreement of a customer in regard to position information collection.

12. The communication terminal used in the watercraft information collecting system according to claim 1.

13. The server used in the watercraft information collecting system according to claim 1.

14. A watercraft comprising:
a hull; and
the onboard system used in the watercraft information collecting system according to claim 1.
